(19) United States
(12) Patent Application Publication
(10) Pub. No.: US 2006/0101274 A1
(43) Pub. Date: May 11, 2006

(54) Data transfer in an access system

(75) Inventors: Robert J. Merkert SR., Voorhees, NJ (US); Meenakshisundaram Manickavelu, Chennai (IN)

Correspondence Address: LAW OFFICES OF STUART J. FRIEDMAN, 28930 RIDGE ROAD, MT. AIRY, MD, 21771, US

(73) Assignee: SCM Microsystems GmbH, Ismaning (DE)

(21) Appl. No.: 10/982,430

(22) Filed: Nov. 5, 2004

(51) Int. Cl. H04L 9/00

(52) U.S. Cl. 713/182

(57) ABSTRACT

An access system includes an access terminal and a control panel. The access terminal is accessible to a user and capable of reading an authentication and/or identification information provided by the user. The control panel is located in a secure area remote from the input device and capable of initiating a security relevant operation. The access system further comprises an interface unit between the control panel and the access terminal. The control panel and the access terminal are physically connected with each other through the interface unit. The physical connection includes a given cabling. The interface unit has the functionality of automatically establishing one of a plurality of predefined data transfer modes depending on determined characteristics regarding the given cabling.

### BACKGROUND OF THE INVENTION

The invention relates to an access system and a method for transferring data between a control panel and an access terminal of an access system.

Secure access systems using access terminals including a Wiegand or magnetic stripe card reader are well known and widely employed in various applications like systems for unlocking doors or parking garage gates etc. A control panel is connected to the access terminal and adapted to evaluate the data retrieved from a user's card. After a positive evaluation of the data, the control panel initiates a security relevant operation (e.g. unlocking of a door). While the access terminal is located so as to be accessible to the user (card holder), the control panel is located in an area which is not accessible to the user, e.g. in a closed room, to guarantee a certain level of security.

The invention aims to improve the communication between the access terminal and the control panel, in particular in access systems with legacy control panels and/or legacy access terminals with pre-laid cabling between them.

### SUMMARY OF THE INVENTION

The access system according to the invention comprises an access terminal and a control panel. The access terminal is accessible to a user and capable of reading an authentication and/or identification information provided by the user. The control panel is located in a secure area remote from the input device and capable of initiating a security relevant operation. The access system further comprises an interface unit between the control panel and the access terminal. The control panel and the access terminal are physically connected with each other. The physical connection includes a given cabling. The interface unit has the functionality of automatically establishing one of a plurality of predefined data transfer modes depending on determined characteristics regarding the given cabling. In particular, such characteristics may include the number, type and the length of available signal lines. The interface unit is preferably embedded in the control panel.

In an access system as described above the method for transferring data between the access terminal and the control panel according to the invention comprises the steps of determining certain characteristics regarding the given cabling, and automatically establishing one of a plurality of predefined data transfer modes depending on the determined characteristics.

The invention defines a control panel interface by adding multiple modes of operation which can provide for higher speed and bi-directional communication.

The functionality of the interface unit according to the invention allows an access terminal to perform a variety of data and/or control information exchanges or communications with a control panel at the same time across a single point-to-point link. It is to be noted that the protocol used to establish the communication is not a device control language. The protocol provides a packet-based, non-blocking flow control system and operates over at least one specific interface in a point-to-point fashion. The protocol is specified in a manner to enable the usage of legacy access terminals and to provide the flexibility for scaling the protocol appropriately for implementations with specific security access terminals instead of legacy terminals.

### BRIEF DESCRIPTION OF THE DRAWINGS

FIG. 1 is a simplified block diagram of an access system according to a first embodiment of the invention;

FIG. 2 is a simplified block diagram of an access system according to a second embodiment of the invention;

FIGS. 3 and 4 are functional flow diagrams of the first embodiment and of the second and third embodiments, respectively;

FIGS. 5 and 6 show the command/status transfer,

FIGS. 7a-7e shows different data transfer modes, and

FIG. 8 a is a graphic representation of the timing of a self-clocked di-phase protocol.

### DETAILED DESCRIPTION OF THE PREFERRED EMBODIMENTS

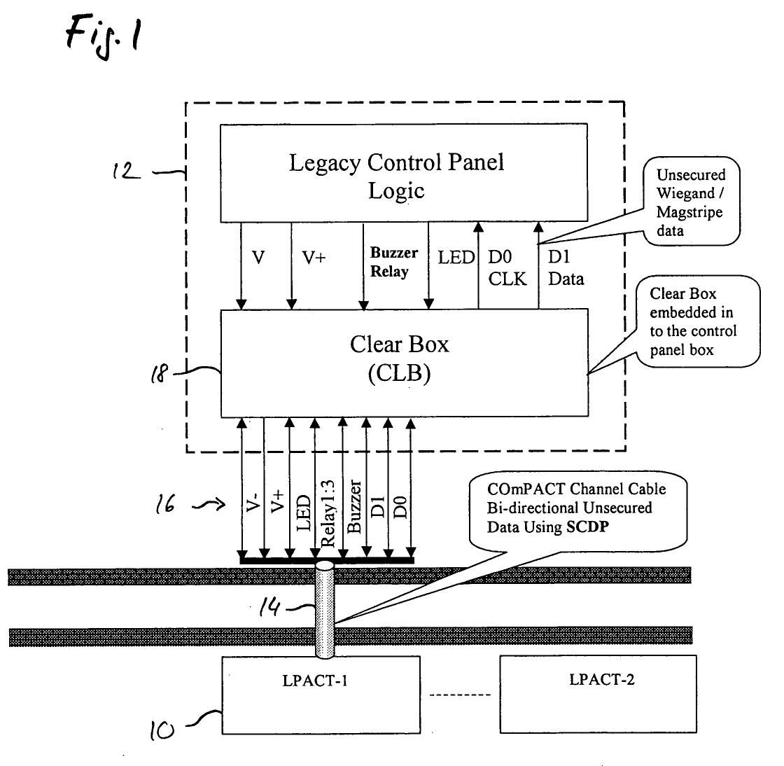

The logical diagram of FIG. 1 shows an access system with a given access terminal 10 that is accessible to a user and includes a common Wiegand card reader or a magnetic stripe card reader, for example. This kind of access terminal is hereinafter referred to as a “legacy physical access control terminal” (LPACT) 10. The LPACT 10 is connected to a control panel 12 that is located in a secure area via a given cable connection (channel) 14 including several physical signal lines 16. The control panel is a given control panel (“legacy control panel”, LCP) 12 that is adapted to initiate security relevant operations. According to the example depicted in FIG. 1 the LCP 12 is adapted to process Wiegand or magnetic stripe data. However, any other protocol, like RS 485 for example, could be supported by the LCP 12.

Embedded in the LCP 12 is an additional hardware unit referred to as “clear box” (CLB) 18. The CLB 18 acts as an interface between the LPACT 10 and the LCP 12 and provides a specific signal switching protocol for establishing a bi-directional data transfer between the LPACT 10 and the LCP 12 as will be described further below. If the data format output by the LPACT 10 is not compatible with the LCP 12, the CLB 18 will convert the data transferred from the LPACT 10 into the Wiegand or magnetic stripe format expected by the LCP 12. The CLB 18 does not have any explicit host interfaces apart from the Wiegand/magnetic stripe interface to the LCP 12. However, multiple LPACTs may be interfaced with a single CLB 18.

This first embodiment of the invention enables unsecured bi-directional data transfer between the LPACT 10 and the LCP 12.

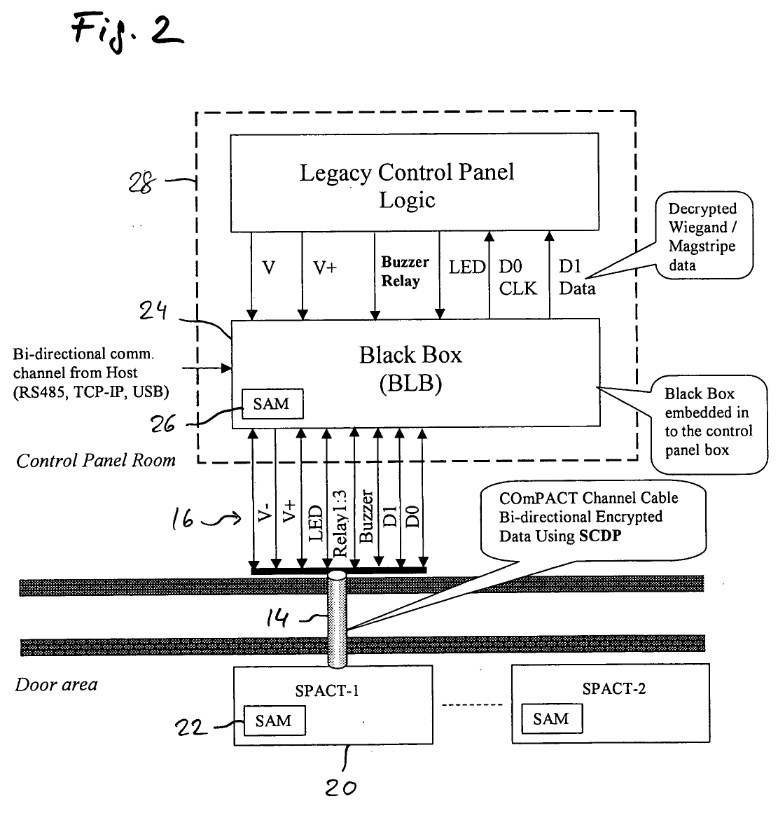

The diagram of FIG. 2 shows a more sophisticated embodiment of the invention. The LPACTs of the embodiment shown in FIG. 1 are replaced by “security enabled physical access control terminals” (SPACTs) 20 including a secure authentication module (SAM) 22. Instead of a CLB a specific “black box” (BLB) 24 including a further SAM 26 is embedded in the control panel. The combination of a legacy control panel 12 and a BLB 24 is referred to as a “security enabled control panel” (SCP) 28. The protocol used for the bi-directional data transfer between the SPACT 20 and the SCP 28, however, is the same as in the first embodiment.

In a third embodiment of the invention one or more LPACTs 10 are used in connection with a BLB 24 equipped SCP 28.

The second and third embodiments of the invention enable secured bi-directional data transfer between the SPACT 20/LPACT 10 and the SCP 28.

The specific protocol used for the data transfer in all embodiments of the invention provides an advanced method of configuring the available interface signal lines 16 without the need to rewire an existing wiring between a control panel and an access terminal. In case of a BLB 24 being used, data is transferred in encrypted form. As there are various ways of configuring the signal lines 16, the protocol supports various transfer modes suiting any access terminal environments as will be described further below.

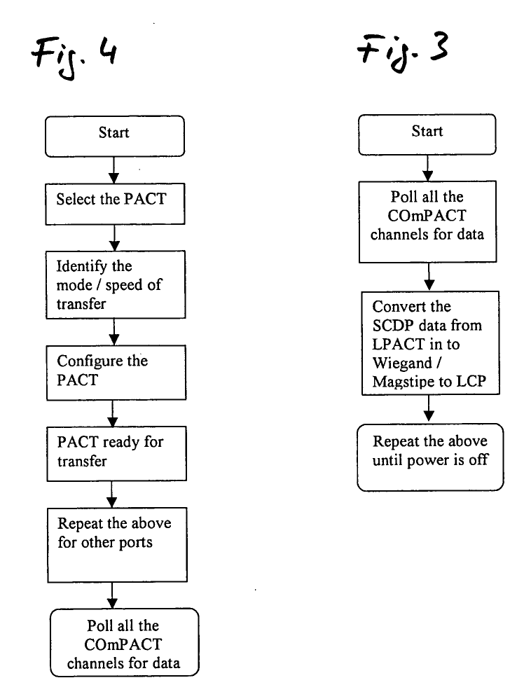

FIG. 3 shows a functional flow diagram of the first embodiment of the invention using a CLB 18 and an LPACT 10, while FIG. 4 shows a functional flow diagram of the second and third embodiments of the invention using a BLB 24 and an LPACT 10 or an SPACT 20, respectively.

According to the flow diagram of FIG. 4, after power-on the BLB 24 selects each port, negotiates with the LPACT 10 or SPACT 20, selects the mode and speed of data transfer and starts polling the channel 14 for any indication of data transfer start. When the LPACT 10 or SPACT 20 is ready with the data it can initiate the data transfer by providing a start sequence. The BLB 24 has the required intelligence to select, initialize, control, and deselect the LPACTs 10 and/or SPACTs 20 connected to it.

In case of a CLB implementation (see FIG. 3), the CLB will simply go into the pass-through mode for connecting the incoming LED, Buzzer, Relay, and power to the downstream LPACT 10. However, the upstream data from the LPACT 10 will be converted into Wiegand or magnetic stripe format by the CLB 18 and passed on to the LCP 12.

In the following the physical configuration of the channel between an access terminal and a CLB 18 or BLB 24 according to the invention is described. It is recalled that the access terminal (LPACT 10 or SPACT 20) and the control panel (LPC 12 or SPC 28) can be used by connecting the access terminal on one end and the control panel on the other end of a pre-laid cabling 14. There is no need to change the cabling 14.

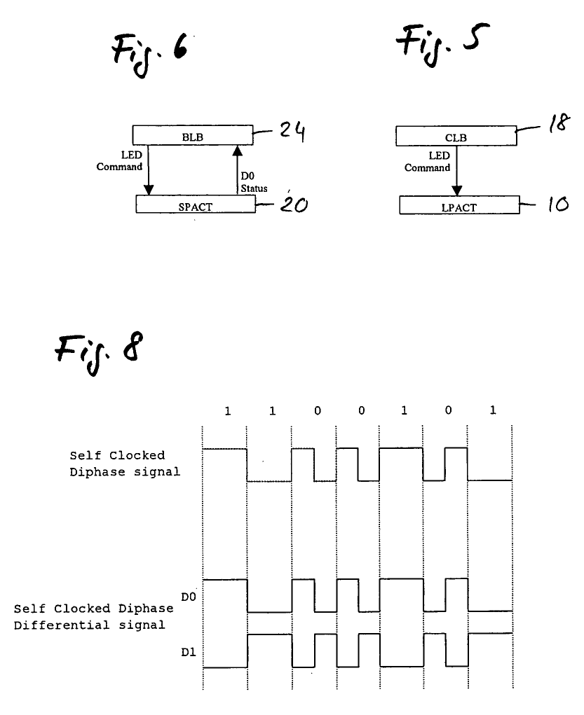

The channel according to the invention contains seven signals: D0, D1, LED, Relay [1:3], and Buzzer. The command/status and data are transferred in separate methods as shown in FIGS. 5 and 6. The command is always written through LED signal line from the control panel to the access terminal, and the status in case of a BLB is always received by the control panel through D0 from the access terminal. In case of a CLB 18 there is no status involved.

For transferring data, seven modes of operation are provided:

2BV Mode—2-bit voltage switching read using D0, D1 for SPACT 10 and BLB 24 combination.

2BI Mode—2-bit current switching read/write using D0, D1 with SPACT 20 and BLB 24 combination.

4BV Mode—4-bit voltage switching read/write using D0, D1, LED, and Buzzer with SPACT 20 or LPACT 10 and BLB 24 combination.

4BI Mode—4-bit current switching read/write using D0, D1, LED, and Buzzer with SPACT 20 and BLB 24 combination.

4BR Mode—4-bit RLE read/write using D0, D1, LED, Buzzer, and Relay[1:3]. RLE stands for run-length-encoding scheme. The relay controls are used as RL (run length), IRD and interrupt signals. The RL signal indicates whether the next nibble is the same as the present one so that it can be locally copied, and the data need not be transferred physically through the interface channel 14.

1BD Mode—1-bit voltage switching differential read using D0, D1 for SPACT 10 and BLB 24 combination.

LEG Mode—Legacy mode for LPACT 10 and CLB 18 combination.

Other modes could also be realized, for example a 1 bit non-differential voltage switching mode between LPACT/SPACT and BLB/CLB. In general, all other modes recognized as combination and/or simplification of the above-described modes are within the scope of the present invention.

The digital voltage switching transfer modes use a voltage switching scheme that is a conventional positive logic protocol. The logic 0 and 1 are indicated by less than or equal to 0.7 V and more than or equal to 2.5 V, respectively. The advantages of these modes are (a) simple implementation and usage, and (b) cost effectiveness. The disadvantages are (a) proneness to noise while transferring the data through long cables, and (b) limitation of the transfer rate by the cable length due to the slow rate.

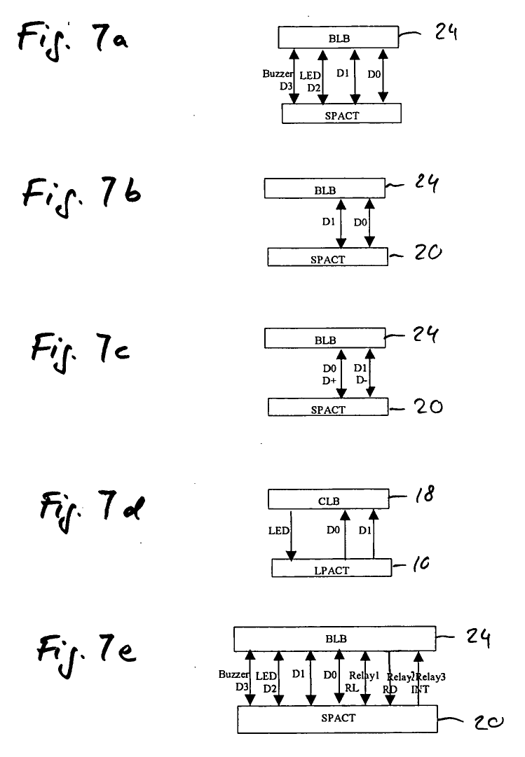

The digital transfer modes can be divided into three sub-modes: 2-bit Mode, 4-bit Mode and 1 bit Mode. In all these modes, the data can always be transferred through at least two bit data signal lines called D0 and D1. Subject to the given cable infrastructure the LED and the Buzzer signal lines can also be used for reading and/or writing data. It is the width of the data transfer which makes the difference between these modes which are further explained below in connection with FIGS. 7a-7e. The data transfer rate (throughput) is a direct function of the number of signal lines used. This determines the speed of the interface between the control panel and the access terminal.

4BV MODE as shown in FIG. 7a yields a high throughput. The data lines are bi-directional with data travelling to and from the access terminal four bits at a time. All the four signal lines are voltage switched in a specific SCDP (self-clocked di-phase) method. SCDP as “self”-clocked signal does not require the communication of a clock signal, thus offering the advantage of reducing the number of signal lines. The clock remains internal to the converter and to the reader. There is no need to communicate any clock signal between both devices. SCDP signal states change with every bit. The advantages of using SCDP compared with known alternative prior art methods, such as non-return to zero (NRZ) and RS 232, will become apparent from the following discussion of those prior art methods:

Non-return to zero encoding is commonly used in slow-speed communications interfaces for both synchronous and asynchronous transmission. Using NRZ, a logic 1 bit is sent as a high value and a logic 0 bit is sent as a low value (the line driver chip used to connect the cable may subsequently invert these signals). There is a problem when NRZ is used to encode a synchronous link which has long runs of consecutive bits with the same value. FIG. 9 illustrates this problem which would arise if NRZ encoding were used with a DPLL (Digital Phase Locked Loop) recovered clock signal. In fact, there is no control over the number of 1's or 0's which may be sent consecutively (there could potentially be thousands of 1's or 0's in sequence). If the encoded data contains long runs of logic 1's or 0's, no bit transitions occur. The lack of transitions prevents the receiver DPLL from reliably regenerating the clock, thus making it impossible to detect the boundaries of the received bits at the receiver.

RS 232 is most widely used in PC environments or in simple terminal serial communications. In asynchronous serial communication, the electrical interface is held in the mark position between characters. The start of transmission of a character is signalled by a drop in the signal level to the space level. At this point, the receiver starts its clock. After one bit (the start bit) 8 bits of true data follow, which, in turn, are followed by one or more stop bits at the mark level, as shown in FIG. 10. The receiver tries to sample the signal in the middle of each bit time. The bit will be read correctly if the line is still in the intended state when the last stop bit is read. Thus, the transmitter and receiver only have approximately the same clock rate. An arithmetic calculation shows that for a 10 bit sequence, the last bit will be interpreted correctly even if the sender and receiver clocks differ by as much as 5%. In general, asynchronous communication is relatively simple and therefore inexpensive. However, in this case it has a high overhead, in that each byte carries at least two extra bits, resulting in a 25% loss of line bandwidth. A 56 kbps line can only carry 5600 bytes/second asynchronously, in ideal conditions.

2BV MODE as shown in FIG. 7b yields moderate throughput. The data lines are bi-directional with data travelling to and from the access terminal two bits at a time. Both the signal lines are voltage switched in a specific SCDP (self-clocked di-phase) method.

1BD MODE as shown in FIG. 7c yields low throughput. The data lines are bi-directional with data travelling to and from the access terminal one bit at a time. Both the signal lines are voltage switched in a specific SCDP (self-clocked di-phase). A single bit is transmitted in two mutually opposite phases (differential) with reference to the ground. D+ is transferred through the D0 signal line and D− is transferred through the D1 signal line. The advantage of a differential mode is that it is more immune to noise than a single-ended mode.

LEG MODE as shown in FIG. 7d is the mode used with the LPACTs 10. The LED is used as control/data signal line from the control panel to the LPACT 10, and D0 and D1 are used to transfer data and status from the LPACT 10 to the control panel.

4BR MODE as shown in FIG. 7e is a further mode that can be used with SPACTs 20. The data lines are bi-directional with data travelling to and from the SPACT 20 four bits at a time. The relay controls are used as RL (run length), RD and interrupt signal lines. The RL signal indicates whether the next nibble is the same as the present one so that it can be locally copied, and the data need not be transferred physically through the interface channel 14. The IRD signal indicates the direction of data transfer. This mode uses the voltage switching method.

The current switching transfer modes use a current switching method that is suitable only for BLB 24-SPACT 20 combinations. The advantages of these modes are (a) immunity to transmission noises, and (b) a higher transfer rate compared to the digital voltage switching modes. The disadvantages are (a) complex implementation, and (b) cost dependency on the current switchers.

The current switching transfer modes can be divided into two sub-modes: 2-bit Mode and 4-bit Mode. In both of the modes, the data can always be transferred through two bit data signal lines called D0 and D1. Subject to the given cable infrastructure the LED and the Buzzer signal lines can also be used for reading and/or writing data. It is the width of the data transfer which makes the difference between these modes. The modes correspond to the respective voltage switching transfer modes in bit assignments as shown in FIGS. 7a and 7b, except for the voltage vs. current switching schemes. The SCDP transfer protocol is also the same as used in the voltage switching modes.

Subject to the cable characteristics, an appropriate bit timing is negotiated/tested and selected. Supported bit timings include 40 μS/bit, 20 μS/bit, 10 μS/bit and 5 μS/bit. The bit timing parameter together with the transfer mode determines the overall data transfer rate between the BLB 24 and the SPACT 20.

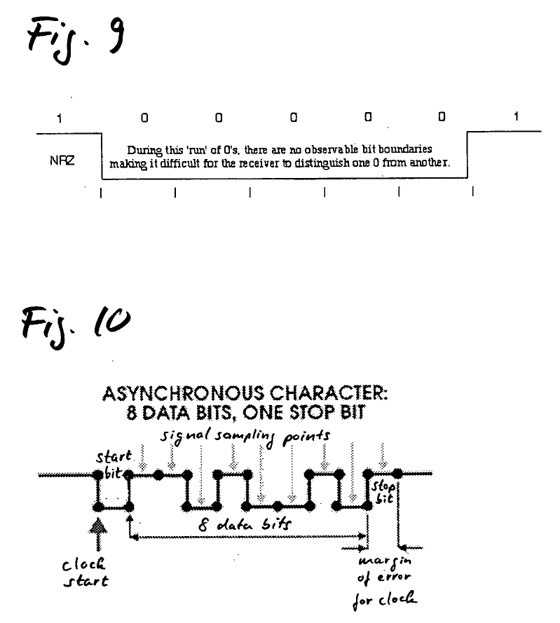

The self-clocked di-phase protocol may be enabled in CLB 18 or BLB 24. The SCDP protocol is shown by way of example in FIG. 8 for simple or differential signals.

A major aspect of the invention is to make use of the existing infrastructure of cable-wiring and arrive at a best possible mode and speed of communication between a control panel and an access terminal including a reader in a given installation.

The choice of communication mode is done according to a dynamic signal configuration (DSC) procedure.

There is no standard that defines how the many signals between readers and control panels are to be connected for a given purpose. There are various types of cable implementation in the field by various vendors. There are some standards like Wiegand and magnetic stripe (Mag-Stripe) which define only two signals, “D0” and “D1” by Wiegand or “Data” and “Clock” by magnetic stripe. However, beyond the scope of these signal lines, people have added additional control lines for some specific purposes like LED, Relay etc. to communicate the information pertaining to the name of the line. For instance, the signal called LED may be used by the control panel to indicate the reader on how to blink the LED in the reader. So the implementation are “vendor-specific” rather than “standard-defined” as far as the other signals than Data are considered.

The objective of the DSC process is to make use of both standard-defined and vendor-specific signals subject to their availability, and to find out dynamically what would be the optimum mode and speed of communication that can be used in the given environment. For this, during first time installation, the control panel establishes the pseudo-block write mode, sends a set of known data patterns to the reader. After this, the control panel establishes the pseudo-block read mode where in the reader will bounce the data back to the control panel. By comparing the data sent to and received from the reader the control panel decides whether it can use the current mode as a mode of transfer or to change the mode. Likewise, all possible modes of transfers are tried and within each of these modes, there are also tried various transfer speeds.

The transfer mode test is to find out how many signal lines are actually wired between the control panel and the reader, whereas the transfer speed test is to find out what could be the physical/electrical characteristics of the cables used. These characteristics will vary based on the cables' length, the gauge (thickness), the material (such as copper or aluminium), the insulation resistance, the conductor resistance/capacitance on the cables, joints, and connectors etc.

For instance, if the control panel selects the 4BV mode, within this mode it can try various speeds of operation. Here, speed refers to the time at which each signal could transit from one state to another state. If the cable length is too long then this transition time will be more or vice-versa. The longer the cable is, the higher is the capacitance/resistance, so the longer the signal takes to settle on a new state. The longer the settling time, the software should wait for more time between each transition of the state of signals on the cable so that the data is transferred without any error between the control panel and the reader.

Likewise, all the possible speeds are tried in all possible modes and finally the control panel finds out the optimum mode and speed of transfer for a given interface channel 14 to the reader. Likewise, it can do the same tests for other channels where the readers are connected at different distances at different places. So the control panel will have unique values of modes/speeds for each of the readers connected to it.

What is claimed is:

1. An access system comprising an access terminal and a control panel,
the access terminal being accessible to a user and capable of reading an authentication and/or identification information provided by the user,
the control panel being located in a secure area remote from the input device and capable of initiating a security relevant operation,
the access system further comprising an interface unit between the control panel and the access terminal,
the control panel and the access terminal being physically connected with each other through the interface unit, the physical connection including a given cabling,
the interface unit having the functionality of automatically establishing one of a plurality of predefined data transfer modes depending on determined characteristics regarding the given cabling.

2. A method for transferring data between an access terminal and a control panel in an access system comprising an access terminal and a control panel, the access terminal being accessible to a user and capable of reading an authentication and/or identification information provided by the user, the control panel being located in a secure area remote from the input device and capable of initiating a security relevant operation, the control panel and the access terminal being physically connected with each other, the physical connection including a given cabling, the method comprising the steps of:
determining certain characteristics regarding the given cabling, and
automatically establishing one of a plurality of predefined data transfer modes depending on the determined characteristics.

3. The method according to claim 2, wherein a self-clocked di-phase protocol is used to transfer the data between the access terminal and the control panel.

4. The method according to claim 2, wherein the step of automatically establishing one of a plurality of predefined data transfer modes includes a dynamic signal configuration process to test the communication lines between the access terminal and the control panel in order to establish the most efficient mode and speed.
